(19) United States
(12) Patent Application Publication
(10) Pub. No.: US 2017/0363483 A1
(43) Pub. Date: Dec. 21, 2017

(54) SURFACE ACOUSTIC WAVE (SAW) BASED TEMPERATURE SENSING FOR ELECTRICAL CONDUCTOR

(71) Applicant: 3M INNOVATIVE PROPERTIES COMPANY, St. Paul, MN (US)

(72) Inventors: Sihua Yuan, Shanghai (CN); Zhiguo Wen, Shanghai (CN); Zheng Huang, Shanghai (CN); Xuetao Yu, Shanghai (CN); Gaofei Guo, Shanghai (CN); Ming Zhang, Shanghai (CN); Justin M. Johnson, Hudson, WI (US); Ronald D. Jesme, Plymouth, MN (US); Jaewon Kim, Woodbury, MN (US)

(21) Appl. No.: 15/540,630

(22) PCT Filed: Dec. 30, 2014
(86) PCT No.: PCT/CN2014/095555

§ 371 Date: Jun. 29, 2017

(51) Int. Cl. G01K 11/26

(52) U.S. Cl. CPC G01K 11/265

(57) ABSTRACT

Systems and methods for directly sensing, measuring, or monitoring the temperature of an electrical conductor (31) of a power cable (10), are provided. A surface acoustic wave (SAW) temperature sensor (20) is used that includes a substrate (20S) with a transducer (20T) disposed thereon. The transducer (20T) conducts conversion between an electromagnetic signal and a SAW signal that propagates on the substrate (20S). At least a portion of the substrate (20S) is disposed in thermal contact with the electrical conductor (31) such that the SAW signal varies with the temperature of the electrical conductor (31).

### TECHNICAL FIELD

The present disclosure relates to systems for monitoring temperature of an electrical conductor, and in particular, to systems for monitoring temperature of an electrical conductor enclosed in at least a (semi)conductive layer, for example, an electrical conductor of an electrical power cable in a power distribution system.

### BACKGROUND

Medium and high voltage power distribution systems play an important role in modern society. Safety and security are always considerable factors for the “health” of a power distribution system. Accordingly, there should be a technology that enables monitoring of the “health” of the power distribution system.

In a power distribution system such as a medium or high voltage power distribution system, the temperature of conductors of electrical cables may increase as currents carried by the cables increase. Accordingly, the “health” of such system can be assessed by monitoring the temperature of the on-line electrical conductor, for example, at the cable splices or the junctions, which may be the weak points, in such a system. Usually, normal currents flowing through the cable splices or the junctions may create a temperature of up to, for example, about 90° C. If the temperatures of the cable splices or the junctions were to increase beyond that, it could be an indication that something may be wrong in this power distribution system. On the other hand, it is also useful to know if the existing power distribution system is at maximum current carrying capacity, to know if additional power can be reliably distributed with the existing system, or, to know if additional infrastructure expenditures are needed.

### SUMMARY

On-line power cables, as well as the cable splices and the junctions, for example, in medium or high voltage power distribution systems are typically insulated and protected by a number of insulative and (semi)conductive layers and/or are commonly buried underground or are positioned high overhead. There is a desire to directly monitor or measure the temperature of the on-line electrical conductor, for example, directly at the cable splices or the junctions.

Briefly, in one aspect, the present disclosure describes systems and methods for directly sensing, measuring, or monitoring the temperature of an electrical conductor of a power cable. Some embodiments described herein provide a surface acoustic wave (SAW) temperature sensor that is in thermal contact with the electrical conductor. The SAW temperature sensor includes an antenna to receive a wireless signal. The received signal can be converted into a SAW signal that can vary with the temperature of the electrical conductor. The temperature of the electrical conductor can be sensed, measured, or monitored by measuring the SAW signal.

In one aspect, a temperature-sensing apparatus for sensing a temperature of an electrical conductor enclosed in at least a (semi)conductive layer, is provided. The apparatus includes a surface acoustic wave (SAW) temperature sensor including a substrate having a major surface, a transducer disposed on the major surface of the substrate, and one or more antennas electrically connected to the transducer. The one or more antennas are configured to receive or send an electromagnetic signal, and the transducer is configured to conduct conversion between the electromagnetic signal and a SAW signal that propagates on the major surface of the substrate. At least a portion of the substrate of the SAW temperature sensor is disposed in thermal contact with the electrical conductor, and the SAW signal varies with the temperature of the electrical conductor.

In another aspect, an electrical cable assembly includes an electrical conductor, a (semi)conductive layer enclosing the electrical conductor, and a temperature-sensing apparatus. The temperature-sensing apparatus includes a surface acoustic wave (SAW) temperature sensor including a substrate having a major surface, a transducer disposed on the major surface of the substrate, and one or more antennas electrically connected to the transducer. The one or more antennas are configured to receive or send an electromagnetic signal, and the transducer is configured to conduct conversion between the electromagnetic signal and a SAW signal that propagates on the major surface of the substrate. At least a portion of the substrate of the SAW temperature sensor is disposed in thermal contact with the electrical conductor, and the SAW signal varies with the temperature of the electrical conductor. The SAW temperature sensor is disposed between the electrical conductor and the (semi)conductive layer, and is enclosed by the (semi)conductive layer. The (semi)conductive layer is configured to provide electromagnetic shielding for the power carried by the electrical conductor, while allowing the electromagnetic signal of the one or more sensor antennas to pass therethrough.

In yet another aspect, a method of sensing a temperature of an electrical conductor enclosed in at least a (semi)conductive layer, is provided. The method includes providing a surface acoustic wave (SAW) temperature sensor. The SAW temperature sensor includes a substrate having a major surface, a transducer disposed on the major surface of the substrate, and one or more antennas electrically connected to the transducer. The one or more antennas are configured to receive or send an electromagnetic signal, and the transducer is configured to conduct conversion between the electromagnetic signal and a SAW signal that propagates on the major surface of the substrate. The method further includes disposing at least a portion of the substrate to be in thermal contact with the electrical conductor such that the SAW signal varies with the temperature of the electrical conductor, providing a transceiver unit configured to be in electromagnetic communication with the one or more antennas of the SAW temperature sensor, detecting, via the electromagnetic communication between the transceiver unit and the one or more antennas, the SAW signal that varies with the temperature of the electrical conductor, and determining the temperature of the electrical transmission line based on the detected SAW signal.

Various unexpected results and advantages are obtained in exemplary embodiments of the disclosure. One such advantage of exemplary embodiments of the present disclosure is that some passive SAW temperature sensors used herein are hermetically sealed to provide accurate temperature measurement with no external physical stress or change in the mechanics of the device even in harsh temperature environments. In addition, the embodiments described herein allow the passive SAW temperature sensors to be in efficient electromagnetic communication with an outside, remote transceiver unit.

### LISTING OF EXEMPLARY EMBODIMENTS

Exemplary embodiments are listed below as aspects. It is to be understood that any of embodiments 1 to 14 and 15 to 17 can be combined.

Embodiment 1 is a temperature-sensing apparatus for sensing a temperature of an electrical conductor enclosed in at least a (semi)conductive layer, the apparatus comprising:

a surface acoustic wave (SAW) temperature sensor including a substrate having a major surface, a transducer disposed on the major surface of the substrate, and one or more sensor antennas electrically connected to the transducer, the one or more sensor antennas being configured to receive or send an electromagnetic signal, and the transducer being configured to conduct conversion between the electromagnetic signal and a SAW signal that propagates on the major surface of the substrate,

wherein at least a portion of the substrate is disposed in thermal contact with the electrical conductor, and the SAW signal varies with the temperature of the electrical conductor.

Embodiment 2 is the apparatus of embodiment 1, wherein the transducer includes an interdigital transducer (IDT).

Embodiment 3 is the apparatus of embodiment 1 or 2, wherein the SAW temperature sensor further includes one or more reflectors disposed on the major surface of the substrate, the one or more reflectors each being disposed to reflect at least a portion of the SAW signal back to the transducer.

Embodiment 4 is the apparatus of any one of embodiments 1-3, wherein the SAW temperature sensor further comprises a metallic housing to accommodate the substrate with the transducer, and the sensor antennas are disposed outside the metallic housing.

Embodiment 5 is the apparatus of any one of embodiments 1-4, wherein the SAW temperature sensor is disposed between the electrical conductor and the (semi)conductive layer, and is enclosed by the (semi)conductive layer.

Embodiment 6 is the apparatus of any one of embodiments 1-5, wherein the substrate includes one or more piezoelectric materials.

Embodiment 7 is the apparatus of any one of embodiments 1-6, further comprising a transceiver unit in electromagnetic communication with the one or more sensor antennas, and the transceiver unit being configured to send out a signal representing the SAW signal and the temperature of the electrical conductor.

Embodiment 8 is the apparatus of embodiment 6, wherein the transceiver unit is disposed outside of the (semi)conductive layer.

Embodiment 9 is the apparatus of any one of embodiments 1-8, wherein the electromagnetic signal has a frequency in a VHF/UHF range.

Embodiment 10 is the apparatus of any one of embodiments1-9, wherein the electrical conductor carries an electrical power having a frequency of 60 Hz.

Embodiment 11 is an electrical cable assembly comprising:

an electrical conductor;

a (semi)conductive layer enclosing the electrical conductor; and

the temperature-sensing apparatus of any one of embodiments 1-10,

wherein the SAW temperature sensor is disposed between the electrical conductor and the (semi)conductive layer, and is enclosed by the (semi)conductive layer, and

wherein the (semi)conductive layer is configured to provide electromagnetic shielding for the power carried by the electrical conductor, while allowing the electromagnetic signal of the one or more sensor antennas to pass therethrough.

Embodiment 12 is the electrical cable assembly of embodiment 11, wherein the (semi)conductive layer includes strips of electrically conductive tapes that extend along a longitudinal axis of the electrical conductor.

Embodiment 13 is the electrical cable assembly of embodiment 11 or 12, wherein the (semi)conductive layer includes one or more electrically conductive tapes that are configured to have gaps serving as windows to allow the electromagnetic signal of the one or more antennas to pass therethrough.

Embodiment 14 is the electrical cable assembly of embodiment 13, wherein the (semi)conductive layer includes an insulating layer that allows for wrapping the one or more electrically conductive tapes around the electrical conductor.

Embodiment 15 is a method of sensing a temperature of an electrical conductor enclosed in at least a (semi)conductive layer, the method comprising:

providing a surface acoustic wave (SAW) temperature sensor, the SAW temperature sensor including a substrate having a major surface, a transducer disposed on the major surface of the substrate, and one or more antennas electrically connected to the transducer, the one or more antennas being configured to receive or send an electromagnetic signal, and the transducer being configured to conduct conversion between the electromagnetic signal and a SAW signal that propagates on the major surface of the substrate;

disposing at least a portion of the substrate to be in thermal contact with the electrical conductor, the SAW signal being variable with the temperature of the electrical conductor;

providing a transceiver unit configured to be in electromagnetic communication with the one or more antennas of the SAW temperature sensor;

detecting, via the electromagnetic communication between the transceiver unit and the one or more antennas, the SAW signal that is variable with the temperature of the electrical conductor; and

determining the temperature of the electrical transmission line based on the detected SAW signal.

Embodiment 16 is the method of embodiment 15, further comprising providing a (semi)conductive layer to enclose the SAW temperature sensor and the electrical conductor, and the SAW temperature sensor being disposed between the (semi)conductive layer and the electrical conductor.

Embodiment 17 is the method of embodiment 15 or 16, wherein the (semi)conductive layer is configured to provide electromagnetic shielding for the power carried by the electrical conductor, while allowing the electromagnetic signal of the one or more antennas to pass therethrough.

As used in this specification:

“(semi)conductive” indicates that the layer may be semi-conductive or conductive, depending on the particular construction.

“thermal contact” between two articles means that the articles can exchange energy with each other in the form of heat.

“direct contact” between two articles means physical contact.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic block diagram of a SAW temperature sensor, according to one embodiment.

FIG. 2 is a schematic block diagram of a system for monitoring temperature of an electrical conductor, according to one embodiment.

FIG. 3A is a perspective side view of a SAW temperature sensor, according to one embodiment.

FIG. 3B is a perspective side view of a SAW temperature sensor, according to another embodiment.

FIG. 4 is a partial cut-away schematic view of application of a system for monitoring temperature of an electrical conductor in a cable splice assembly, according to one embodiment.

FIG. 5 is a sectional view of a portion of the electrical conductor in a cable splice assembly having a passive SAW temperature sensor, according to one embodiment.

FIG. 6 is a partial cross-section side view of a SAW temperature sensor, according to one embodiment.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

The present disclosure provides embodiments of systems and methods for monitoring a temperature of an electrical conductor of, for example, medium or high voltage (e.g., >1 kV or >10 kV) power cables. It may be particularly useful to perform such monitoring by means of a “passive” apparatus, by which is meant an apparatus that does not require an internal power source (e.g., battery) and that does not need to be physically connected to an external power source. In this disclosure, one type of passive apparatus that can find use in such applications relies on a temperature sensitive surface acoustic wave (SAW) device or a SAW temperature sensor.

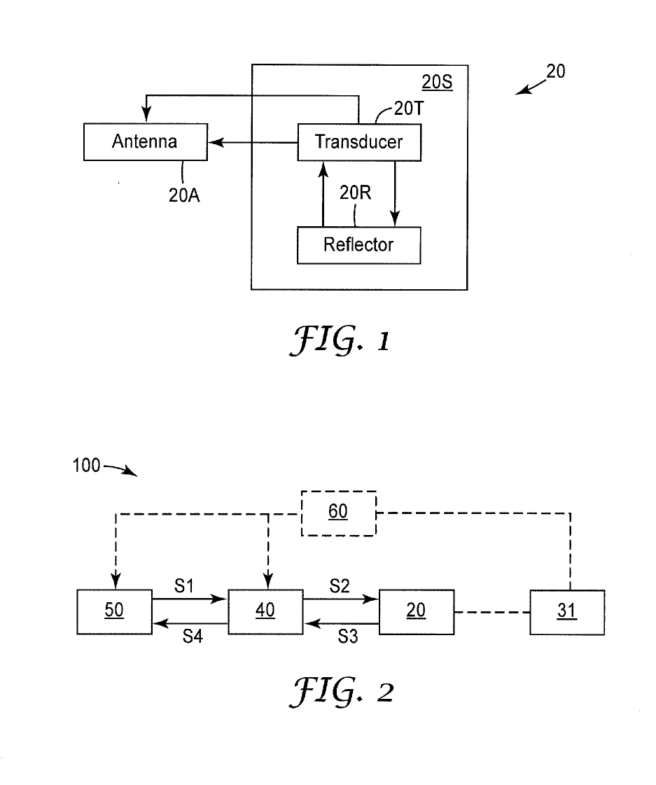

FIG. 1 illustrates a schematic block diagram of a SAW temperature sensor 20, according to one embodiment. The SAW temperature sensor 20 includes a transducer 20T disposed on a major surface of a substrate 20S. The substrate 20S can be, for example, a piezoelectric substrate including one or more piezoelectric materials. The SAW temperature sensor 20 further includes an antenna 20A configured to receive and send electromagnetic signals. In some embodiments, the electromagnetic signals can be in the very high or ultra-high frequency (VHF/UHF) band (e.g., from 30 MHz to 3 GHz). The antenna 20A is electrically connected to the transducer 20T. The transducer 20T is configured to receive the electromagnetic signal from the antenna 20A and convert the received electromagnetic signal into a SAW signal by, for example, a converse piezoelectric effect. The SAW signal can propagate on the major surface of the substrate 20S as acoustic waves. In the embodiment of FIG. 1, the SAW temperature sensor 20 further includes one or more reflectors 20R. At least a portion of the acoustic waves can be reflected by the reflectors 20R back to the transducer 20T where the reflected SAW signal can be re-converted into electromagnetic signals to be sent out by the antenna 20A.

It is to be understood that the reflectors 20R can be optional. The SAW temperature sensor 20 can include any suitable elements for guiding, modulating, or converting the acoustic waves. In some embodiments, the SAW temperature sensor 20 may not include the reflectors 20R, and instead can include a second transducer to receive a SAW signal as acoustic waves from the transducer 20T, without first reflecting from a reflector, and re-convert the received SAW signal into electromagnetic signal to be sent out by a second antenna electrically connected to the second transducer.

In some embodiments, some components of the SAW temperature sensor 20 including the substrate 20S with the transducer 20T and the reflector 20R disposed thereon can be hermetically sealed inside a package. The package can be, for example, a hermetically sealed ceramic or metal package. The antenna 20A can be disposed outside the package and electrically connected to the transducer 20T via, for example, pins of the package and a transmission wire such as, for example, a coaxial cable.

The temperature of the substrate 20S can affect properties (e.g., velocity, amplitude, phase, frequency, etc.) of the acoustic waves propagating thereon. When the temperature of the substrate 20S of the SAW temperature sensor 20 changes, the acoustic waves propagating on the major surface of the substrate 20S can be modulated by the temperature change. Accordingly, the properties of the electromagnetic signal re-converted from the SAW signal can be modulated. In some embodiments disclosed herein, the SAW signal can be used to sense, measure or monitor the temperature of the substrate 20S. When the SAW temperature sensor 20 is placed in thermal communication or contact with a portion of a power cable, a change in temperature of that portion of the power cable can cause the temperature of the temperature sensitive SAW device to change commensurately. This temperature change can modulate the SAW signal and the correspondingly re-converted electromagnetic signal, which can be detected and used to infer the temperature of that portion of the power cable.

FIG. 2 is a schematic diagram of a system 100 for monitoring a temperature of an electrical conductor 31 according to one embodiment. The system 100 includes the passive SAW temperature sensor 20 of FIG. 1, a transceiver unit 40, and a control unit 50. The passive SAW temperature sensor 20 is disposed to have at least a portion of the substrate 20S to be in thermal contact with the outer surface of the electrical conductor 31 such that the acoustic waves propagating on the substrate 20S can be variable with the temperature of the electrical conductor 31.

In some embodiments, the passive SAW temperature sensor 20 can receive an electromagnetic signal from the transceiver unit 40 and send out a feedback electromagnetic signal that varies with the temperature of the electrical conductor 31. The control unit 50 can communicate with the transceiver unit 40 to determine a value of the temperature of the electrical conductor 31 based on the feedback electromagnetic signal. In some embodiments, the system 100 may further include an optional central monitoring unit (not shown in FIG. 2). The optional central monitoring unit can communicate with the control unit 50 wirelessly (e.g., through mobile network) or through wires to receive the determined value of the temperature of the electrical conductor 31 and make decisions accordingly.

In some embodiments, during operation, if there is a need to monitor the temperature of the electrical conductor 31, the control unit 50 may send out an instruction signal S1 to the transceiver unit 40. Once the transceiver unit 40 receives the instruction signal S 1, it then sends out an electromagnetic signal S2 to the passive SAW temperature sensor 20. The passive SAW temperature sensor 20 can receive the electromagnetic signal S2 and convert it into a SAW signal. The SAW signal can vary with the temperature of the electrical conductor 31, for example, being modulated by the temperature change of the electrical conductor 31. The SAW signal then can be re-converted into a feedback electromagnetic signal S3. The transceiver unit 40 can detect the feedback electromagnetic signal S3 from the passive SAW temperature sensor 20 and then send out a signal S4 to the control unit 50. The feedback electromagnetic signal S3 and the signal S4 contain the information representing the SAW signal of the passive SAW temperature sensor 20, which can be variable with the temperature of the electrical conductor 31. The control unit 50 can determine a value of the temperature of the electrical conductor 31 based on the ascertained signal S4.

In some embodiments, the absolute temperature of the electrical conductor 31 can be determined by the control unit 50 based on the measured feedback electromagnetic signal S3. In some embodiments, a temperature change of the electrical conductor 31 can be determined by the control unit 50 based on the measured feedback electromagnetic signal S3 and the absolute temperature of the electrical conductor 31 can be determined accordingly.

In some embodiments, the system 100 may further include an optional energy harvesting unit 60. The energy harvesting unit 60 can be adapted to harvest electrical power from the electrical conductor 31 when an AC current flows through the electrical conductor 31 and to supply the harvested electrical power to the transceiver unit 40 and/or the control unit 50.

In some embodiments, the passive SAW temperature sensor 20 can measure the temperature of the electrical conductor 31 in a temperature range of, for example, from −55° C. to 150° C. with a temperature accuracy of, for example, +/−2° C. or better.

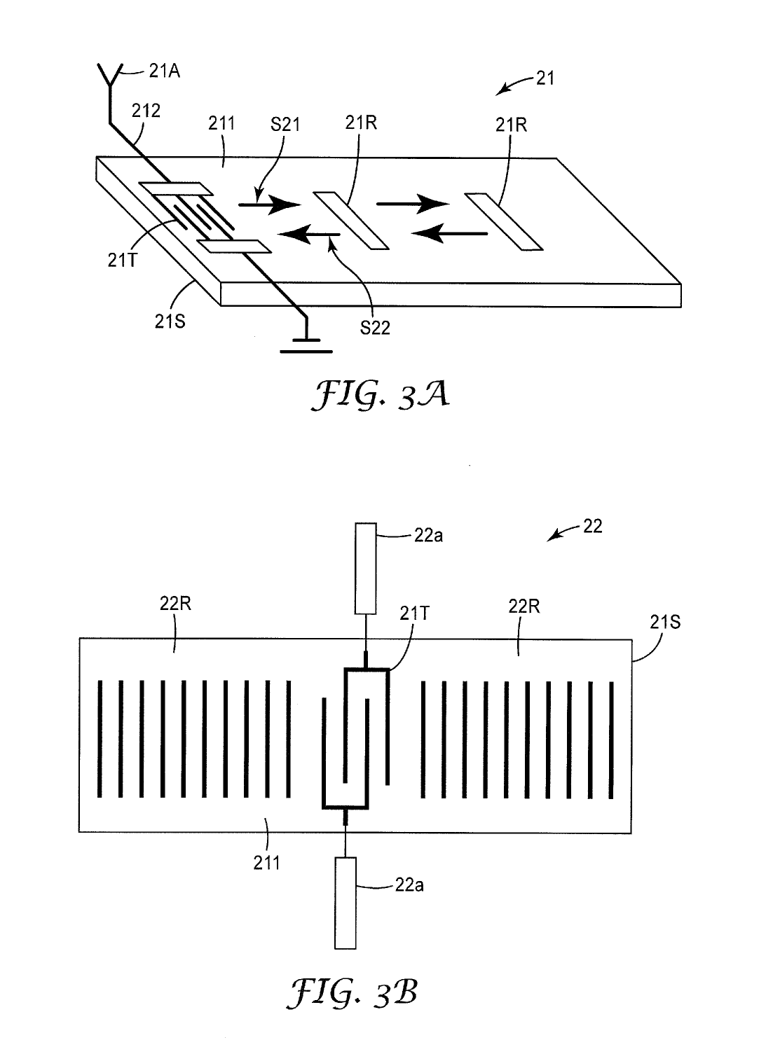

FIGS. 3A-B illustrate two examples 21 and 22 for the passive SAW temperature sensor 20 of FIGS. 1 and 2, according to some embodiments. The passive SAW temperature sensor 21 of FIG. 3A includes a piezoelectric substrate 21S, an interdigital transducer (IDT) 21T disposed on a major surface 211 of the substrate 21S, and an antenna 21A electrically connected, via a wire 212, to the IDT 21T.

The antenna 21A is configured to receive a wireless signal such as, for example, an electromagnetic signal in the VHF/UHF band from the transceiver unit 40 of FIG. 2. The IDT 21T is configured to convert the electromagnetic signal received by the antenna 21A into a SAW signal S21. The SAW signal S21 propagates on the major surface 211 of the substrate 21S as acoustic waves. The passive SAW temperature sensor 21 further includes one or more reflectors 21R disposed on the major surface 211 of the substrate 21S. The reflectors 21R each are configured to reflect at least a portion of the SAW signal S21 back to the IDT 21T. The reflected SAW signal S22 can be received by the IDT 21T and re-converted into a feedback electromagnetic signal to be sent out by the antenna 21A.

In some embodiments, the piezoelectric substrate 21S can include one or more piezoelectric materials. The piezoelectric material can be any suitable natural or synthetic materials that exhibit piezoelectricity including, for example, barium titanate, lead zirconate titanate, potassium niobate, lithium niobate, lithium tantanate, sodium tungstate, sodium potassium niobate, bismuth ferrite, sodium niobate, bismuth titanate, sodium bismuth titanate, polymers such as polyvinylidene fluoride, etc.

During operation, at least a portion of the piezoelectric substrate 21S is in thermal contact with the electrical conductor 31 of FIG. 2. When the temperature of the electrical conductor 31 is changed, the acoustic waves can be modulated by the temperature change. The temperature of the electrical conductor 31 can be determined based on the feedback electromagnetic signal. In the embodiment of FIG. 3B, the passive SAW temperature sensor 22 includes a series of reflectors 22R disposed on two sides of the IDT 21T and two antennas 22A electrically connected to terminals of the IDT 21T where the IDT 21T is disposed in a central portion of the piezoelectric substrate 21S. In the embodiment of FIG. 3A, the IDT 21T is disposed adjacent to an edge of the piezoelectric substrate 21S. It is to be understood that one or more IDTs and one or more reflectors can be arranged in various ways as long as the passive SAW temperature sensor can work properly.

In the embodiment of FIGS. 3A-B, the IDT 21T includes electrodes that are arranged in an interdigitated comb configuration including an arrangement of electrically conductive lines or “fingers”. The electrodes can be disposed on or embedded into the major surface 211 of the piezoelectric substrate 21S. The electrodes can be made of any appropriate electrically conductive materials such as, for example, metals, metal alloys, metal-filled polymers, etc. The fingers can be disposed parallel to each other with a space therebetween. When an input electrical signal is received by the IDT 21T from an antenna (e.g., 21A or 22A), the input electrical signal can create alternating polarity between the fingers of the IDT 21T. The alternating polarity can create alternating regions of tensile and compressive strain on the major surface 211 of the substrate 21S between the fingers of the electrode by a piezoelectric effect of the piezoelectric substrate, and can produce a mechanical wave thereon known as a surface acoustic wave (SAW). The wavelength of the mechanical or acoustic wave can be the space between the fingers of the electrodes. The frequency f₀ of the acoustic wave can be represent as the following equation:

$${f}_{0} = \frac{{v}_{p}}{p}$$

where Vₚ is the phase velocity of the acoustic wave and p is the space between the fingers.

The generated mechanical or acoustic wave can propagate away from the IDT 21T. In some embodiments, one or more mechanical absorber can be added between the IDT 21T and the edges of the piezoelectric substrate 21S to prevent interference patterns or control insertion losses. The acoustic wave travels across the surface of the substrate and can be reflected by one or more reflectors back to the IDT 21T and re-converted into electromagnetic feedback signals by a piezoelectric effect. In some embodiments, the acoustic wave can travel to other IDT, converting the acoustic wave back into a feedback signal by the piezoelectric effect. Any changes that were made to the mechanical or acoustic wave can be reflected in the feedback signal. In the present disclosure, the SAW signal varies with the temperature of the electrical conductor which can be determined based on the feedback signal.

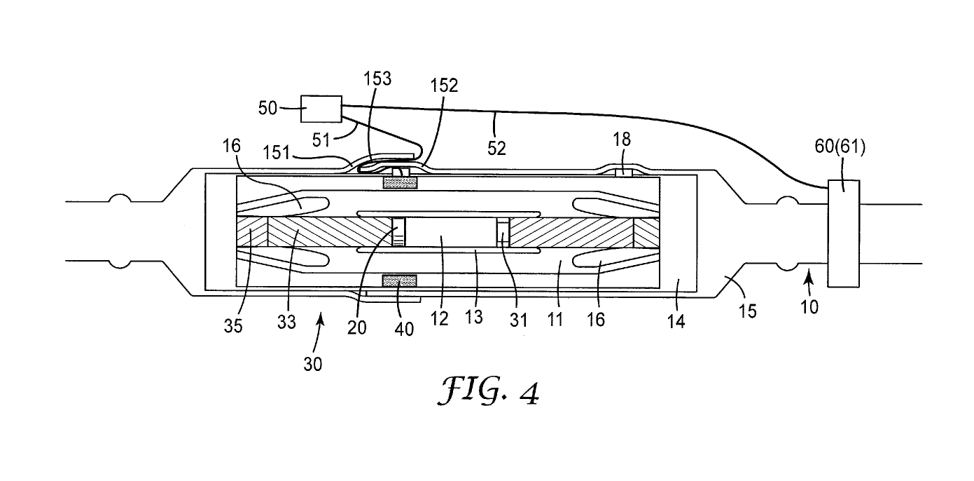

FIG. 4 illustrates application of the system 100 of FIG. 2 including the passive SAW temperature sensor 20, the transceiver unit 40, and the control unit 50 for monitoring or measuring temperature of the electrical conductor 31, for example enclosed in a cable splice assembly 30, according to one embodiment.

In the cable splice assembly 30, two sections of an electrical cable 10 are spliced. Each section of the electrical cable 10 includes the electrical conductor 31, an insulation layer 33, and a (semi)conductive layer 35. The insulation layer 33 and the (semi)conductive layer 35 enclose the electrical conductor 31. A connector 12 concentrically surrounds the spliced electrical conductors 31. A first (semi)conductive (or electrode) layer 13, in this case a metallic layer, concentrically surrounds the spliced electrical conductors 31 and the connector 12, forming a shielding Faraday cage around the connector 12 and the electrical conductors 31. In some embodiments, “(semi)conductive” indicates that the layer may be semi-conductive or conductive, depending on the particular construction. An insulating layer 11 (containing geometric stress control elements 16) surrounds the first (semi)conductive layer 13. The foregoing construction is placed inside a second (semi)conductive layer 14, in this case a metallic housing, which functions as a shield and ground layer. A resin can be poured into the metallic housing 14 through one of the ports 18 to fill in the area around insulating layer 11. A shrinkable sleeve layer 15 serves as an outermost layer.

In this embodiment, portions of the electrical conductors 31 are covered by the connector 12 and then are enclosed by the first (semi)conductive layer 13, the insulating layer 11, the second (semi)conductive layer 14, and the shrinkable sleeve layer 15. In this embodiment, the shrinkable sleeve layer 15 includes two overlapping sections 151 and 152 to leave a passage 153 between the overlapping portions. The passage 153 is from the outside of the shrinkable sleeve layer 15 through the port 18 on the second (semi)conductive layer 14 to the inside of the second (semi)conductive layer 14.

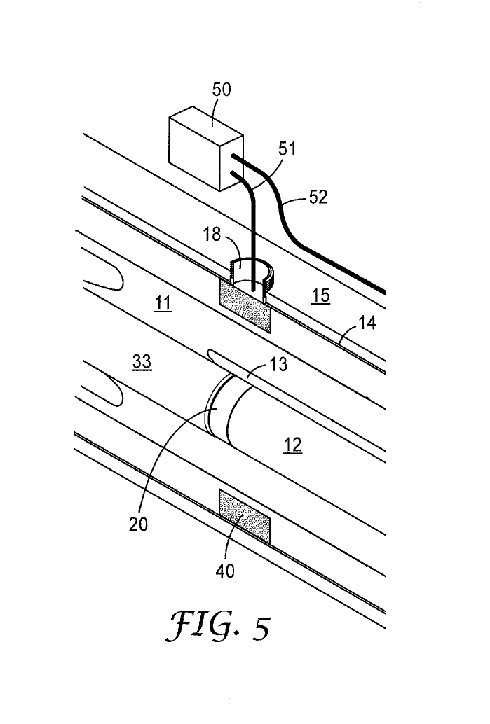

As shown in FIG. 4, the passive SAW temperature sensor 20 is positioned adjacent to one of the electrical conductors 31 and inside the first (semi)conductive layer 13. Preferably, a portion of the electrical conductor 31 is exposed between the insulation layer 33 of the electrical cable 10 and the connector 12, and the passive SAW temperature sensor 20 may be positioned at an outer surface of the exposed portion of the electrical conductor 31. More detailed description about the position of the passive SAW temperature sensor 20 will be given hereinafter with reference to FIG. 5.

The transceiver unit 40 is positioned outside the first (semi)conductive layer 13 and inside the second (semi)conductive layer 14, i.e. between the first (semi)conductive layer 13 and the second (semi)conductive layer 14. The transceiver unit 40 can include an antenna that can be any type of antenna including, for example, an inductive coil, a printed antenna, etc. The transceiver unit 40 can include two or more antennas that can be positioned around the insulating layer 11 of FIG. 4. In some embodiments, the antenna of the transceiver unit 40 and the antenna 21A of the passive SAW temperature sensor 20 can be located in a same cross section, so as to improve the electromagnetic communication therebetween. More detailed description about embodiments of the transceiver unit 40 and its positioning will be provided hereinafter with reference to FIG. 5.

In some embodiments, pairings of the passive SAW temperature sensor 20 and the transceiver unit 40 can be located at various locations of the electrical cable 10. The passive SAW temperature sensor 20 can be disposed adjacent to the electrical conductor 31 and enclosed by the (semi)conductive layer 35 and the insulation layer 33 of the electrical cable 10. The transceiver unit 40 can be located outside the (semi)conductive layer 35 and configured to be in electromagnetic communication with the antenna 20A of the passive SAW temperature sensor 20. A series of such pairings can be distributed along the electrical cable 10 to provide a temperature distribution of the electrical conductor 31.

Referring again to FIG. 4, the control unit 50 is configured to communicate with the transceiver unit 40 through a wire 51. The wire 51 can be accommodated within the passage 153 so that the wire 51 can extend from the transceiver unit 40, through the port 18, to the control unit 50. The optional energy harvesting unit 60 including a power inductive coil 61 can be located outside the assembly 30 and around the cable 10, or located between the second (semi)conductive layer 14 and the shrinkable sleeve layer 15. The energy harvesting unit 60 can be used to supply power to the transceiver unit 40 and/or the control unit 50 through a wire 52. Throughout this specification, although the wire 51 and the wire 52 are each referred to as a “wire,” it should be understood that either or both of wire 51 and wire 52 may include multiple wires as needed for the system to function.

In some embodiments, the inductive coil 61 of the optional energy harvesting unit 60 can include, for example, an iron-core current transformer, an air-core current transformer, or a Rogowski coil. The inductive coil 61 can be positioned outside the first (semi)conductive layer 13, or outside the second (semi)conductive layer if one is used. Preferably, the energy harvesting unit 60 may be used mainly to provide the harvested electrical power to the transceiver unit 40, so the energy harvesting unit 60 can be positioned outside the layer in which the transceiver unit 40 is located. Thus, the energy harvesting unit 60 may be electrically connected with the transceiver unit 40 via one or more wires. In some embodiments, the energy harvesting unit 60 may further include an optional rectifier circuit to adapt the harvested electrical power right for the transceiver unit 40 and/or the control unit 50.

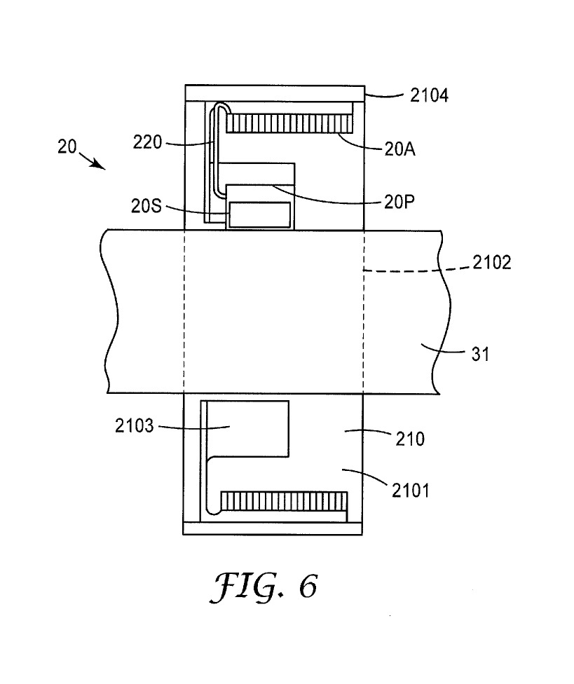

FIG. 5 illustrates a closer perspective view illustrating an exemplary location of the passive SAW temperature sensor 20 of FIG. 4 that is placed on the electrical conductor 31 adjacent to the connector 12. FIG. 6 is a cross-sectional view of the passive SAW temperature sensor 20, according to one embodiment. In the embodiment of FIG. 5, the shrinkable sleeve layer 15 is continuous and a hole has been cut in the shrinkable sleeve layer 15 to accommodate the port 18 and allow the egress of the wire 51.

As an example, the passive SAW temperature sensor 20 of FIG. 6 includes the antenna 20A and the substrate 20S with the transducer 20T, the reflector 20S and other components disposed thereon. The substrate 20S and the components disposed thereon are hermetically sealed inside a package 20P. The package 20P can be, for example, a hermetically sealed ceramic or metal package. In some embodiments, the package 20P can provide a housing with a cavity to receive the substrate 20S where the substrate 20S can be mounted on a wall of the housing. The housing can be made of electrically conductive material such as, for example, copper. The antenna 20A and the transducer 20T (not shown) on the substrate 20S are electrically connected via a transmission line 220 which can be, for example, a coaxial cable.

A fixture 210 is provided to install the antenna 20A and the package 20P. In the embodiment of FIG. 6, the fixture 210 includes a main body 2101 and a channel 2102. The channel 2102 is adapted to accommodate the electrical conductor 31 to have the electrical conductor 31 pass through the channel 2102. The main body 2101 has a chamber 2103 to accommodate the package 20P and the chamber 2103 can communicate with the channel 2102 in a way that at least a portion of the substrate 20S inside the package 20P can be in thermal contact with the outer surface of the electrical conductor 31 in operation. The antenna 20A can be adapted to various configurations/geometries to promote the electromagnetic communication with the transceiver unit 40 that is disposed outside of the first (semi)conductive layer 13 as shown in FIG. 5. The fixture 210 further includes a cover 2104 to enclose the main body 2101. It is to be understood that two or more antennas 20A, and/or two or more packages 20P can be accommodated in the fixture 210 where the antennas and the IDTs inside the packages can be electrically connected in various ways.

Referring again to FIGS. 6 and 7, at least a portion of the substrate 20S of the passive SAW temperature sensor 20 is disposed in thermal contact with the electrical conductor 31. In some embodiments, the package 20P that seals the substrate 20S can adhere to the surface of the electrical conductor 31 by, for example, a thermal-conductive paste. In some embodiments, the package 20P can be in direct contact with the surface of the electrical conductor 31. It is to be understood that the package 20P can be any suitable shapes as long as a suitable thermal contact surface can be provided to effectively exchange heat between the substrate 20S and the electrical conductor 31.

In some embodiments such as the embodiment shown in FIGS. 4 and 6, the passive SAW temperature sensor 20 including the antenna 20A is located inside an electromagnetic shielding layer such as the first (semi)conductive (or electrode) layer 13 or the (semi)conductive layer 35, and the transceiver unit 40 is located outside of the electromagnetic shielding layer. The electromagnetic shielding layer surrounds the electrical conductor 31 and/or the connector 12, providing an effective shield of the electrical power carried by the electrical conductor 31. For example, the first (semi)conductive (or electrode) layer 13 can shield angular discharges on the connector 12 caused by crimping. In some embodiments, the power carried by the electrical conductor 31 has a frequency of, for example, 60 Hz. The present disclosure recognizes that an electromagnetic shielding layer such as the first (semi)conductive (or electrode) layer 13 or the (semi)conductive layer 35, if improperly designed, may affect the electromagnetic communication between the antenna 20A of the passive SAW temperature sensor 20 and the transceiver unit 40.

Some embodiments in the present disclosure to be described below provide one or more (semi)conductive layers such as the first (semi)conductive (or electrode) layer 13 or the (semi)conductive layer 35. The (semi)conductive layer surrounds and encloses the electrical conductor 31 and the passive SAW temperature sensor 20. The transceiver unit 40 is disposed outside the (semi)conductive layer. The (semi)conductive layer is configured to provide electromagnetic shielding of the power carried by the electrical conductor 31, without significantly affecting the electromagnetic communication between the antenna 20A of the passive SAW temperature sensor 20 and the transceiver unit 40.

In some embodiments, the (semi)conductive layer can include one or more electrically conductive tapes that surround the electrical conductor 31. The tapes can be, for example, finely woven mesh tapes including electrically conductive meshes. Example tapes are commercially available from 3M Company (Saint Paul, Minn., USA) under the trade designations Scotch 24 Electrical Shielding Tape, which are conducting metal taps being woven of tinned copper wire and capable of operating at a temperature of 130° C. In some embodiments, multiple tapes are arranged to have a gap or space therebetween. In other embodiments, a single tape can be used that includes gaps or spaces between electrically conductive meshes thereof. The gaps or spaces can serve as windows to allow electromagnetic communication between the antenna 20A of the passive SAW temperature sensor 20 and the transceiver unit 40. The gaps or spaces can have a dimension of, for example, from 0.05 mm to 25 mm, or from 0.1 mm to 10 mm. Without the spaces or gaps, the (semi)conductive layer may block the electromagnetic signal from the antenna 20A or the transceiver unit 40 to be transmitted therethrough.

In some embodiments, the (semi)conductive layer can further include an insulating base layer that allows for wrapping the one or more electrically conductive tapes around the electrical conductor 31 to form an electrically conductive surface. The electrically conductive surface with the gaps or spaces can form a frequency selective surface, which can be relatively transparent to electromagnetic signals of a specific range of frequencies (e.g., in a VHF/UHV range) while relatively shielding to the electrical power carried by the electrical conductor 31.

In some embodiments, the (semi)conductive layer can include strips of electrically conductive tapes that extend along a longitudinal axis of the electrical conductor and wrap around the outside of the electrical conductor. The electrically conductive tapes would not form a cylindrical current loop and possible eddy currents can be suppressed. The suppression of the eddy currents can help an electromagnetic signal in the VHF/UHV range to transmit therethrough.

Some embodiments described herein provide temperature-sensing apparatus that include a passive SAW temperature sensor. The passive SAW temperature sensor can be hermetically sealed system which can be exposed to harsh temperature environments and measure the temperature of an electrical conductor with no external physical stress or change in the mechanics of the sensor. Some passive SAW temperature sensors described herein can undergo many cycles of measurement without inducing failure mechanisms such as, for example, mechanical stress.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, various exemplary embodiments have been described. These and other embodiments are within the scope of the following claims.

1. A temperature-sensing apparatus for sensing a temperature of an electrical conductor enclosed in at least a (semi)conductive layer, the apparatus comprising:
a surface acoustic wave (SAW) temperature sensor including a substrate having a major surface, a transducer disposed on the major surface of the substrate, and one or more sensor antennas electrically connected to the transducer, the one or more sensor antennas being configured to receive or send an electromagnetic signal, and the transducer being configured to conduct conversion between the electromagnetic signal and a SAW signal that propagates on the major surface of the substrate,
wherein at least a portion of the substrate is disposed in thermal contact with the electrical conductor, and the SAW signal varies with the temperature of the electrical conductor.

2. The apparatus of claim 1, wherein the transducer includes an interdigital transducer (IDT).

3. The apparatus of claim 1, wherein the SAW temperature sensor further includes one or more reflectors disposed on the major surface of the substrate, the one or more reflectors each being disposed to reflect at least a portion of the SAW signal back to the transducer.

4. The apparatus of claim 1, wherein the SAW temperature sensor further comprises a metallic housing to accommodate the substrate with the transducer, and the one or more sensor antennas are disposed outside the metallic housing.

5. The apparatus of claim 1, wherein the SAW temperature sensor is disposed between the electrical conductor and the (semi)conductive layer, and is enclosed by the (semi)conductive layer.

6. The apparatus of claim 1, wherein the substrate includes one or more piezoelectric materials.

7. The apparatus of claim 1, further comprising a transceiver unit in electromagnetic communication with the one or more sensor antennas, and the transceiver unit being configured to send out a signal representing the SAW signal and the temperature of the electrical conductor.

8. The apparatus of claim 7, wherein the transceiver unit is disposed outside of the (semi)conductive layer.

9. The apparatus of any one of claims claim 1, wherein the electromagnetic signal has a frequency in a VHF/UHF range.

10. The apparatus of claim 1, wherein the electrical conductor carries an electrical power having a frequency of 60 Hz.

11. An electrical cable assembly comprising:
an electrical conductor;
a (semi)conductive layer enclosing the electrical conductor; and
the temperature-sensing apparatus of claim 1,
wherein the SAW temperature sensor is disposed between the electrical conductor and the (semi)conductive layer, and is enclosed by the (semi)conductive layer, and
wherein the (semi)conductive layer is configured to provide electromagnetic shielding for the power carried by the electrical conductor, while allowing the electromagnetic signal of the one or more sensor antennas to pass therethrough.

12. The electrical cable assembly of claim 11, wherein the (semi)conductive layer includes strips of electrically conductive tapes that extend along a longitudinal axis of the electrical conductor.

13. The electrical cable assembly of claim 11, wherein the (semi)conductive layer includes one or more electrically conductive tapes that are configured to have gaps serving as windows to allow the electromagnetic signal of the one or more antennas to pass therethrough.

14. The electrical cable assembly of claim 13, wherein the (semi)conductive layer includes an insulating base layer that allows for wrapping the one or more electrically conductive tapes around the electrical conductor.

15. A method of sensing a temperature of an electrical conductor enclosed in at least a (semi)conductive layer, the method comprising:
providing a surface acoustic wave (SAW) temperature sensor, the SAW temperature sensor including a substrate having a major surface, a transducer disposed on the major surface of the substrate, and one or more antennas electrically connected to the transducer, the one or more antennas being configured to receive or send an electromagnetic signal, and the transducer being configured to conduct conversion between the electromagnetic signal and a SAW signal that propagates on the major surface of the substrate;
disposing at least a portion of the substrate to be in thermal contact with the electrical conductor, the SAW signal being variable with the temperature of the electrical conductor;
providing a transceiver unit configured to be in electromagnetic communication with the one or more antennas of the SAW temperature sensor;
detecting, via the electromagnetic communication between the transceiver unit and the one or more antennas, the SAW signal that is variable with the temperature of the electrical conductor; and
determining the temperature of the electrical transmission line based on the detected SAW signal.

16. The method of claim 15, further comprising providing a (semi)conductive layer to enclose the SAW temperature sensor and the electrical conductor, and the SAW temperature sensor being disposed between the (semi)conductive layer and the electrical conductor.

17. The method of claim 16, wherein the (semi)conductive layer is configured to provide electromagnetic shielding for the power carried by the electrical conductor, while allowing the electromagnetic signal of the one or more antennas to pass therethrough.
